(19) United States
(12) Patent Application Publication
(10) Pub. No.: US 2026/0186735 A1
(43) Pub. Date: Jul. 2, 2026

(54) SYSTEM FOR CONTROL OVER HEADSET AND METHOD THEREFOR

(71) Applicant: Harman International Industries, Incorporated, Stamford, CT (US)

(72) Inventors: Sebastiaan GRUIJTERS, Shenzhen (CN); Mikael HERJE, Shenzhen (CN); Yenfai CHAU, Shenzhen (CN)

(73) Assignee: Harman International Industries, Incorporated, Stamford, CT (US)

(21) Appl. No.: 19/549,481

(22) Filed: Feb. 25, 2026

Related U.S. Application Data
(63) Continuation of application No. PCT/CN2023/121098, filed on Sep. 25, 2023.

(51) Int. Cl. G06F 3/16; A63F 13/54; H04R 1/10

(52) U.S. Cl. CPC G06F 3/165; A63F 13/54; G06F 3/162; H04R 1/1041; H04R 2420/07

(57) ABSTRACT

A system for full control over a headset that includes an audio source device for running media and output audio, a headset for receiving the audio transmitted from the audio source device and playback, and an app device installed with a proprietary application for controlling settings of the headset. The headset may be connected to the audio source device via a wireless connection for transmitting audio, while the headset may be connected to the app device via a Bluetooth connection for being controlled via the proprietary application installed on the app device.

### CROSS-REFERENCE TO RELATED APPLICATIONS

This application is a continuation of International Application No. PCT/CN2023/121098, filed on September 25, 2023. The disclosure of the above application is incorporated herein by reference.

### FIELD

The present disclosure relates to control of headsets. More particularly, the present disclosure relates to a system and a method for controlling over headsets.

### BACKGROUND

The statements in this section merely provide background information related to the present disclosure and may not constitute prior art.

It is very common in modern life to connect headsets to media players for listening to the audio alone without affecting others.

Headsets usually can be designed with tuning functions for sound effects. However, due to the current technological inability to access wide different software ecosystems, headsets can only be customized via dedicated software, such as only available on a dedicated Windows operated computer, via a proprietary software suite. It is challenging to customize any headset related advanced audio and feature settings when wirelessly connected to any other related platforms.

There is a need to provide a system and method for controlling over headsets, by which the users may have full access to their headsets, regardless of whether they are playing audio on any platforms they choose.

### SUMMARY

This section provides a general summary of the disclosure and is not a comprehensive disclosure of its full scope or all of its features.

In one form, a system of full control over a headset provided in the present disclosure comprises an audio source device for running media and output audio thereon, a headset for receiving the audio transmitted from the audio source device and playback, and an app device installed with a proprietary application for controlling the settings of the headset. In this system, the audio source device may transmit the audio to the headset through a wireless connection, and the app device may control the settings of the headset through a Bluetooth connection. This allows for uninterrupted audio playback while also adjusting the headset.

In another form, a method of full control over a headset provided in the present disclosure comprises the steps of running media on an audio source device and output audio, receiving, by a headset, the audio transmitted from the source device and playback, and controlling, via a proprietary application installed on an app device, settings of the headset. The method further comprises the steps of transmitting the audio from the audio source device to the headset through a wireless connection, and controlling the settings of the headset via the proprietary application installed on the app device through a Bluetooth connection, allowing for uninterrupted audio playback while also adjusting the headset.

In yet another form, any combination of one or more computer readable medium(s) may be utilized to store instructions which, when processed by a processor, performs the steps of the method of full control over the headset provided in the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an exemplary structural block diagram of the system of full control over the headset, according to one and more embodiments of the present disclosure; and

FIG. 2 illustrates an exemplary flowchart of the method for fully controlling over the headset, according to one and more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The detailed description of the one or more embodiments of the present disclosure is disclosed hereinafter; however, it is understood that the disclosed embodiments are merely exemplary of the present disclosure that may be embodied in various and alternative forms. The figures are not necessarily to scale; some features may be exaggerated or minimized to show details of particular components. Therefore, specific structural and function details disclosed herein are not to be interpreted as limiting, but merely as a representative basis for teaching one skilled in the art to variously employ the present inventive subject matter.

Some headsets, such as music headsets, can create left and right channels to express the level of music, such as vocals, instruments, and scenarios. Some other headsets, such as gaming headsets, generally refer to the headphones with a microphone suitable for playing games. There is no need to reflect all high-quality high, medium, and low frequencies, and even in many cases it is desirable to suppress low frequencies to allow players to hear more high-frequency signals, so as to hear the surrounding environment more clearly. The disclosure mainly takes the game headsets as an example to illustrate the system and method of full control over the headset according to the present disclosure in one or more embodiments, but other headsets, such as the music headphones, are also included herein without departure away the scope of the present disclosure.

As mentioned, the headsets typically can be configured with some tuning functions for controlling the sound effects. Whether for listening to music or playing games, users may choose to use the headsets equipped with built-in chipsets or sound cards, specifically designed to enhance various sound effects based on the user preferences or the game scenarios. In an example of gaming headsets, these sound enhancement processes may be controlled through software applications according to the sound effects of game content (FPS like footsteps, gunshots, etc.).

However, the limitation of existing software is that the headsets are usually only compatible to specialized operating platforms, such as PC Windows. People for example who do not have a PC or are not playing games on it may not be able to adjust settings or they may be not able to have full control over their headsets in real-time. Even for some users who do not have a Windows PC may only have a MacOS device, such software may not be compatible for both. In this case, those game players need to plug their headsets back into their PCs, start the game software application to adjust their settings, and then plug them back to the game devices. However, the game players may not want to break off their gaming sessions on their PCs by quitting the game to adjust the audio settings of their headphones.

The purpose of the present disclosure is to fully control over the headsets without any dedicated PC software suite. This functionality may be enabled through a proprietary application, which can be installed on such as iOS and Android® that connects to the headsets through Bluetooth® connections. In this way, the users can fully customize all settings of the headsets without accessing specialized PC software.

The proprietary application provided allows the users to customize / personalize the settings of the headsets, which otherwise can only be used on a dedicated PC suite on a computer operated with Windows. No matter what platform the users may choose to operate on, they can fully control over their headsets through the proprietary application.

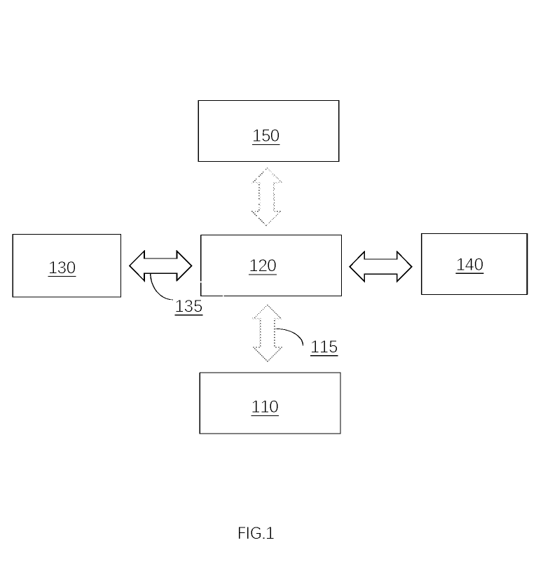

In one aspect of the present disclosure, a system of full control over a headset is provided. FIG. 1 illustrates an exemplary structural block diagram of the system 100 of full control over the headset, according to one and more embodiments of the present disclosure. As shown in FIG. 1, the system 100 comprises at least an audio source device 110 where media are running and output audio, a headset 120 for playing the audio received from the audio source device 110, and an App device 130 installed with the proprietary application thereon to control the headset 120 to customize the user's preference.

In the example of a game player wearing a game headset to play games on a game device, the audio source device 110 can be considered as the game device configured to run games, such as PC, MacOS device, PlayStation® or Nintendo Switch®, etc., and the audio comprising the game sound effects may be output to the game headset 120 via USB output.

In the example, the headset 120 can be a gaming headset with headphones and a microphone that the game players/users can place on their heads. From the game device focusing the smart connectivity concept becomes truly a universal and device agnostic headset that may work seamlessly with any device that allows USB Audio, in particular, as long as using a USB wireless dongle connected to the game device 110. The USB wireless dongle can be operated such as at 2.4 GHz, allowing game devices 110 to wirelessly connect to the headset 120, and enabling the USB audio to be sent thereto, via a wireless connection 115.

At the same time, the app device 130 may be connected with the headset 120 via Bluetooth connection 135, such as Bluetooth® LE. The App device 130 may be the place where, with the proprietary application, every setting and features of the headset can be adjusted. In one and more embodiments of the present disclosure, the App device 130 can be for example a mobile device, such as a smartphone, tablet, personal data assistant, or other mobile device enable of the Bluetooth® connection. Those settings may be transferred to the headset 120 through Bluetooth® connection. Once the settings have been changed accordingly on the headset 120, it will send back an acknowledgement back to the app device 130 and will also reflect in the proprietary application.

In an example, the app device 130 may be used as a remote control for the headset 120, while the audio source comes from elsewhere, such as the audio source device 110. This solves the technical problem of not being able to control the headsets when playing audio from another audio source on a mobile device when Bluetooth® connection is also used between the headset and the audio source. In such way, any app device enabling a Bluetooth® connection can be suitable for the system for the full control herein.

As long as using the USB wireless dongle is used to connect to the audio source device, the audio source in the system can be any audio source device other than the app device. The headset may be controlled via the proprietary application to change numerous settings, including but not limited to:

Connections; RGB light settings such as changing color presets, colors and color effects; audio settings such as adjusting EQ and enabling Surround Sound; Surround Sound settings such as enabling/disabling different Surround Sound options; and/or enabling/disabling headtracking features, different room sizes for different surround sound experiences, and calibration of headtracking according to user's ears; microphone options such as mic gain and sidetone; ANC and TalkThru feature; Save settings in profile; firmware updates, and seeking advice in help section.

In the example of the game headset, the above options can be controlled via the app device without using a Windows PC or quitting of the game, as long as the headset is connected via Bluetooth® connection, it is suitable for the system for fully controlling over the headset herein.

In one and more embodiments of the present disclosure, the headset 120 may be configured with a user interface 140, which for example can be one or more buttons that may adjust the settings of the headset 120, such as changing the Bluetooth® connection, the microphone mute/unmute function etc. These settings adjusted should be transferred back to the proprietary application on the app device 130 as well, in order to maintain full consistency between the hardware and the software.

In one and more embodiments of the present disclosure, the proprietary application installed on the app device 130 makes it able for the users to have full control over the headsets 120. Nevertheless, a local software suite, such as a PC Suite 150, may still exist in the audio source device 110. In the example of the game device, the PC Suite 150 still exists for users that prefer to have control by operating to the game device, such as the Windows PC, and in case some proprietary technologies desire the Windows environment to run on. In an example, even if the method of fully controlling game headsets herein cannot be applicable to PC based spatial/virtualized environments, the PC suite still needs to be manipulated for control. Settings and features that both exist on the local Suite and the proprietary application should be synchronized to achieve a harmonious user experience. The installation of the local Suite is fully optional and do not have a big impact on the total experience of the game players.

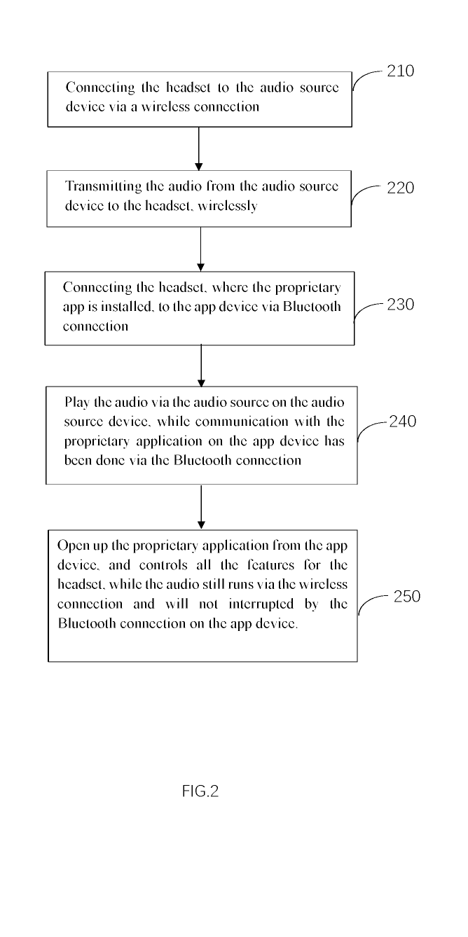

In another aspect of the present disclosure, a method for fully control over headsets is provided. FIG. 2 illustrates an exemplary flowchart of the method for fully control over the headsets, according to one and more embodiments of the present disclosure. As shown in FIG.2, in Step S210, the headset can be connected to the audio source device, such as PC, PlayStation®, Nintendo Switch®, Macbook®, etc, via the wireless connection. In this step, the user may plug the USB wireless dongle into the audio source device. The USB wireless dongle may operate at 2.4Ghz, for example.

In Step S220, the audio from audio source on the audio source device can be transmitted to the headset for playback via the wireless connection. In the one and more embodiments, the audio with the game sound effects from games running on the gaming devices may be transmitted to the gaming headset via the 2.4Ghz wireless connection, and be continuously playback.

In Step 230 then, the headset where the proprietary application is installed may be also connected to the app device via a Bluetooth® connection. Therefore, the app device may have two different connections which can be enabled at the same time, the 2.4Ghz Wireless connection and the Bluetooth connection. Where the 2.4Ghz Wireless connection is used for playing games and media due to the low latency and wider bandwidth, the Bluetooth® LE in this occasion will be used to connect to the app device that can run iOS or Android® apps.

Next, in Step 240, audio will be played via the audio source on the audio source device, while communication with the proprietary application on the app device has been done via the Bluetooth® LE connection. The users do not need to go out of their application sessions and control settings direct via the app devices. The users may control over the settings of their headsets via the app devices due to no connection with the proprietary PC software.

And then, in Step 250, the user may open up the proprietary application from the app device, such as on their mobile device, and controls all the features for the headset, while the audio still runs via the 2.4Ghz USB wireless dongle and will not interrupted by the Bluetooth connection on the app device.

For PC users, the additional load brought by running applications can be their major concern, which now in the system can be fully eliminated. The USB wireless dongle used herein does not have any impact on the CPU Power of the game device. The USB Wireless dongle is connected to the PC (Windows system), and the proprietary software application can be installed on the app device to control the headset. This proprietary software application only does consume a little bit of CPU power when it is activated in Windows. In the present disclosure, the processing power can be moved from the PC to the mobile device, so that they do not have to install the proprietary software application on the PC. This does not apply for game devices that has the USB Wireless dongle connected on PlayStation®, Nintendo Switch® or MacOS® devices as there is no proprietary software installed.

On the other hand, for non-PC users, all settings, such as on the audio source device as well as on the app device, can be fully accessible and easily firmware update. The system and the corresponding method in the present disclosure may enable the users to connect to different audio sources while controlling their settings without being interrupted in the audio. For users who demands the most out of their PC performance, the system and the corresponding method may minimize the CPU load by changing to the app device to control the settings instead of the PC. The users without Windows PC or console gamers can control their headset directly on their app devices. There is no need to buy a Windows PC or go back to the Windows PC to adjust the settings.

In yet another aspect of the present disclosure, a non-transitory computer readable medium storing instruction that can be processed by one or more processors to realize the method for fully control over headsets is provided.

The system and the corresponding method in the present disclosure may enable the users to connect to different audio sources while controlling their settings without being interrupted in the audio. For users who demands the most out of their PC performance, the system and the corresponding method may minimize the CPU load by changing to the app device to control the settings instead of the PC. The users without Windows PC or console gamers can control their headset directly on their app devices. There is no need to buy a Windows PC or go back to the Windows PC to adjust the settings.

The present disclosure comprises, but not limited to, the items listed hereinafter. Item 1: A system for full control over a headset, comprising: an audio source device for running media and output audio; a headset for receiving the audio transmitted from the audio source device and playback; and an app device installed with a proprietary application for controlling settings of the headset. The headset may be connected to the audio source device via a wireless connection for transmitting audio, while the headset may be connected to the app device via a Bluetooth® connection for being controlled via the proprietary application installed on the app device.

Item 2: The system according to item 1, wherein the audio source device is configured with USB output for the audio.

Item 3: The system according to any of Items 1 to 2, wherein a USB wireless dongle is connected to the audio source device for transmit the audio, wherein the USB wireless dongle can operate at 2.4Hz.

Item 4: The system according to any of Items 1 to 3, wherein the audio source device can be at least one of PC, MacOS® device, Play station®, Nintendo Switch®, or tablets.

Item 5: The system according to any of Items 1 to 4, wherein the app device may be connected to the headset via Bluetooth® LE to control it.

Item 6: The system according to any of Items 1 to 5, wherein the headset further comprises a user interface for user to enable/ disable the headset.

Item 7: The system according to any of Items 1 to 6, wherein the user interface may comprise at least one button for changing the Bluetooth® connection and microphone mute/unmute.

Item 8: The system according to any of Items 1 to 7, wherein a PC suite can be existed on the game device, and the features that both exist on the PC Suite and the proprietary application may be synchronized.

Item 9: A method for full control over a headset, comprising following steps of: running, on an audio source device, media and output audio; receiving, by a headset, the audio transmitted from the source device and playback; and controlling, via a proprietary application installed on an app device, settings of the headset. The headset may be connected to the audio source device via a wireless connection for transmitting audio, while the headset may be connected to the app device via a Bluetooth connection for being controlled via the proprietary application installed on the app device.

Item 10: The method according to Item 9, wherein the audio source device is configured with USB output for the audio.

Item 11: The method according to any of Items 9 to 10, wherein a USB wireless dongle is connected to the audio source device for transmit the audio, wherein the USB wireless dongle can operate at 2.4GHz.

Item 12: The method according to any of Items 9 to 11, wherein the audio source device can be at least one of PC, MacOS device, PlayStation, Nintendo Switch, or tablets.

Item 13: The method according to any of Items 9 to 12, wherein the app device may be connected to the headset via Bluetooth connection to control it.

Item 14: The method according to any of Items 9 to 13, wherein the headset further comprises a user interface for user to enable/ disable the headset.

Item 15: The method according to any of Items 9 to 14, wherein the user interface may comprise at least one button for changing the Bluetooth LE and microphone mute/unmute.

Item 16: The method according to any of Items 9 to 15, wherein a PC suite can be existed on the game device, and the features that both exist on the PC Suite and the proprietary application may be synchronized.

Item 17: A non-transitory computer readable medium storing instruction that can be processed by one or more processors to realize the steps of claims 9-16.

As used in this application, an element or step recited in the singular and proceeded with the word "a" or "an" should be understood as not excluding plural of said elements or steps, unless such exclusion is stated. Furthermore, references to "one embodiment" or "one example" of the present disclosure are not intended to be interpreted as excluding the existence of additional embodiments that also incorporate the recited features. The terms "first," "second," and "third," etc. are used merely as labels, and are not intended to impose numerical requirements or a particular positional order on their objects.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for full control over a headset, comprising:
an audio source device for running media and output audio;
a headset for receiving the audio transmitted from the audio source device and playback; and
an app device installed with a proprietary application for controlling settings of the headset,
wherein the headset is connected to the audio source device via a wireless connection for transmitting audio, while the headset is connected to the app device via a Bluetooth connection for being controlled via the proprietary application installed on the app device.

2. The system according to claim 1, wherein the audio source device is configured with USB output for the audio.

3. The system according to claim 2, wherein a USB wireless dongle is connected to the audio source device for transmit the audio, and wherein the USB wireless dongle operates at 2.4Hz.

4. The system according to claim 1, wherein the audio source device is at least one of PC, MacOS® device, PlayStation®, Nintendo Switch®, or tablets.

5. The system according to claim 1, wherein the app device is connected to the headset via Bluetooth® LE.

6. The system according to claim 5, wherein the headset further comprises a user interface for user to enable/ disable the headset.

7. The system according to claim 6, wherein the user interface comprises at least one button for changing the Bluetooth® connection and microphone mute/unmute.

8. The system according to claim 1, wherein a PC suite exists on a game device, and features that both exist on the PC Suite and the proprietary application are synchronized.

9. A method for full control over a headset, comprising following steps of:
running, on an audio source device, media and output audio;
receiving, by a headset, the audio transmitted from the audio source device and playback; and
controlling, via a proprietary application installed on an app device, settings of the headset,
wherein the headset is connected to the audio source device via a wireless connection for transmitting audio, while the headset is connected to the app device via a Bluetooth® connection for being controlled via the proprietary application installed on the app device.

10. The method according to claim 9, wherein the audio source device is configured with USB output for the audio.

11. The method according to claim 9, wherein a USB wireless dongle is connected to the audio source device to transmit the audio, and wherein the USB wireless dongle operates at 2.4GHz.

12. The method according to claim 9, wherein the audio source device is at least one of PC, MacOS device, PlayStation, Nintendo Switch, or tablets.

13. The method according to claim 9, wherein the app device is connected to the headset via Bluetooth® LE.

14. The method according to claim 13, wherein the headset further comprises a user interface for a user to enable/ disable the headset.

15. The method according to claim 14, wherein the user interface comprises at least one button for changing the Bluetooth connection and microphone mute/unmute.

16. The method according to claim 9, wherein a PC suite exists on a game device, and features that both exist on the PC Suite and the proprietary application are synchronized.

17. One or more non-transitory computer-readable media storing processor-executable instructions that, when executed by at least one processor, cause the at least one processor to:
run, on an audio source device, media and output audio;
receive, by a headset, the audio transmitted from the audio source device and playback; and
control, via a proprietary application installed on an app device, settings of the headset,
wherein the headset is connected to the audio source device via a wireless connection for transmitting audio, while the headset is connected to the app device via a Bluetooth® connection for being controlled via the proprietary application installed on the app device.

18. The one or more non-transitory computer-readable media of claim 17, wherein the audio source device is configured with USB output for the audio.

19. The one or more non-transitory computer-readable media of claim 17, wherein a USB wireless dongle is connected to the audio source device to transmit the audio, and wherein the USB wireless dongle operates at 2.4GHz.

20. The one or more non-transitory computer-readable media of claim 17, wherein the audio source device is at least one of PC, MacOS device, PlayStation, Nintendo Switch, or tablets.
